(19) United States
(12) Patent Application Publication
(10) Pub. No.: US 2023/0192461 A1
(43) Pub. Date: Jun. 22, 2023

(54) DRIVERLESS TRANSPORT VEHICLE WITH IMPROVED MAINTAINABILITY

(71) Applicant: Continental Automotive Technologies GmbH, Hannover (DE)

(72) Inventors: Sven Mainz, Hofheim amTaunus (DE); Sascha Gerber, Bad Schwalbach (DE)

(73) Assignee: Continental Automotive Technologies GmbH, Hannover (DE)

(21) Appl. No.: 17/999,392

(22) PCT Filed: May 10, 2021
(86) PCT No.: PCT/DE2021/200063

§ 371 Date: Nov. 18, 2022

(30) Foreign Application Priority Data
May 19, 2020 (DE) 10 2020 206 276.5

(51) Int. Cl. B66F 9/075; B66F 9/06

(52) U.S. Cl. CPC B66F 9/07513; B66F 9/063

(57) ABSTRACT

A driverless automatically guided transport vehicle for conveying payloads, such as a material transport vehicle in a factory, comprises a payload lifting apparatus. For improved ease of maintenance, for example for electrical and electronic components and systems, it is proposed that, in the chassis, there is arranged at least one removable interchangeable module in which multiple electrical and/or electronic components are combined.

### CROSS-REFERENCE TO RELATED APPLICATIONS

The present application is a National Stage Application under 35 U.S.C. § 371 of International Patent Application No. PCT/DE2021/200063 filed on May 10, 2021, and claims priority from German Patent Application No. 10 2020 206 276.5 filed on May 19, 2020, in the German Patent and Trademark Office, the disclosures of which are herein incorporated by reference in their entireties.

### TECHNICAL FIELD

The invention relates to a driverless guided transport vehicle for conveying payloads.

### BACKGROUND

Transport vehicles are normally used as so-called industrial trucks or material transport vehicles in production factories, for example for transporting particular payloads in the warehouse or from the warehouse to the production line, whilst preferably navigating autonomously. In the case of such transport vehicles, the load may be composed both of the payload itself and of a payload carrier that can be separately loaded with the payload - for example a rack, a roller trolley or the like. Here, it is the intention that the transport vehicle can travel under such a payload carrier, independently lift said payload carrier, transport said payload carrier to the destination, and set said payload carrier down again there. For this purpose, the transport vehicle is equipped with an integrated lifting apparatus.

With regard to the known prior art, reference is made by way of example to DE 20 2013 004 209 U1 or EP 102706 A1.

In order to be able to realize the wide variety of functions of the transport vehicle, numerous electrical and electronic components are installed therein. In certain situations, for example in the event of a defect, it should be possible for individual components or entire systems to be checked, and if necessary replaced, as quickly and easily as possible. Owing to the restricted installation space, the affected components can however in some cases be removed and reinstalled only with great effort.

Against this a generic transport vehicle with improved ease of maintenance for example for electrical and electronic components and systems is useful.

### SUMMARY

In a chassis of the transport vehicle, there is arranged a removable interchangeable module in which multiple electrical and/or electronic components are combined.

A major proportion of the electrical and electronic components and systems can thus be preassembled and subsequently inserted into the transport vehicle.

For example in the event of a component defect, for reprogramming or for a planned component exchange, the entire interchangeable module can firstly be quickly and effectively replaced with a compatible intact interchangeable module, and downtimes are thus reduced. Fault finding, fault analysis, programming and exchange of the defective component can be performed at a later point in time in a dust-free environment at an optimally equipped workstation. The heavy and possibly contaminated transport vehicle does not need to be separately transported and cleaned for this purpose, and it is likewise not necessary for any elaborate decontamination measures to be performed at the location of the transport vehicle.

For the manufacture of the vehicles, too, this module can be preassembled entirely independently of the rest of the structure of the transport vehicle, for example by a specialized manufacturer.

Furthermore, differently equipped and/or programmed interchangeable modules, which can be exchanged quickly, can be provided for different task scenarios.

For efficient handling of the interchangeable module, the interchangeable module may have a separate module housing in which the electrical and/or electronic components are accommodated.

For effective use, it is possible, in a refinement, for at least one electronic control unit to be contained within the interchangeable module.

In order to improve the production and maintainability of the transport vehicle and ensure effective protection of the sensitive electronic components, one embodiment provides that the transport vehicle has a front vehicle portion, a middle vehicle portion and a rear vehicle portion, wherein the front vehicle portion is separated from the middle vehicle portion by a front partition, and the rear vehicle portion is separated from the middle vehicle portion by a rear partition, and the interchangeable module is arranged in the middle vehicle portion.

For an effective distribution of functions, the embodiment furthermore proposes that at least one first sensor arrangement for sensing the vehicle surroundings, and at least two vehicle wheels, for example support wheels, are arranged in the front vehicle portion.

For the same reason, the embodiment likewise proposes that at least one second sensor arrangement for sensing the vehicle surroundings, and at least two drive wheels together with associated traction drives, are arranged in the rear vehicle portion.

For improved maintenance of the mechanical components, the embodiment furthermore provides for a lifting drive for actuating the lifting apparatus to be arranged in the middle vehicle portion. Said lifting drive is thus easily accessible, and furthermore, for even better accessibility, the interchangeable module can be quickly removed.

According to the refinement, the lifting apparatus is actuated by way of an eccentric drive. In this way, said lifting apparatus can be simple and robust and at the same time space-saving construction, and furthermore requires less expenditure on control technology, for example in relation to multiple separate, individually actuatable lifting elements. For example, the eccentric elements that are arranged pairwise on each side and are coupled to one another are accommodated in space-saving fashion within the box-like load carrier element.

For connection of electrical and electronic consumers in the transport vehicle, one embodiment provides that electrical and/or electronic components from the front, middle and rear vehicle portions are connected to the interchangeable module via electrical lines.

According to one refinement, for establishment of the electrical connections the interchangeable module may have a small number, for example one single, combined electrical interface(s) which are/is designed for the simultaneous connection of multiple electrical and/or electronic components outside the interchangeable module. For example, according to one refinement, the interchangeable module may have one combined electrical interface for the connection of all consumers in the rear vehicle portion and a further combined electrical interface for the connection of all consumers in the front and middle vehicle portions.

### BRIEF DESCRIPTION OF THE DRAWINGS

The present invention will be discussed in more detail below on the basis of an exemplary embodiment. In the figures:

FIG. 1 is a highly simplified illustration of the transport vehicle in a plan view (view a) and side views with a retracted (b) and deployed (c) lifting apparatus.

FIG. 2 shows views as per FIG. 1, but additionally with a payload carrier.

FIG. 3 is an exemplary illustration of an embodiment of the transport vehicle with a payload in a payload carrier.

FIG. 4 is a three-dimensional illustration of the transport vehicle with an interchangeable module removed (a) and inserted (b).

FIG. 5 is a simplified diagrammatic illustration of the transport vehicle 1 in a plan view.

FIG. 6 is a three-dimensional illustration of an embodiment of a module housing.

FIG. 7 shows a side view of the lifting apparatus in a lifted transport position (a) and a lowered parked position (b).

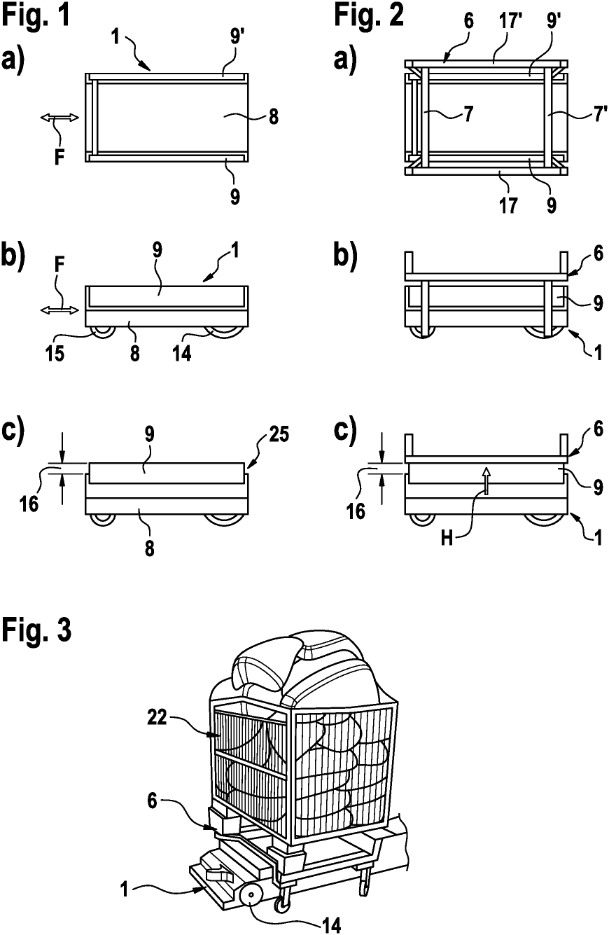

### DETAILED DESCRIPTION

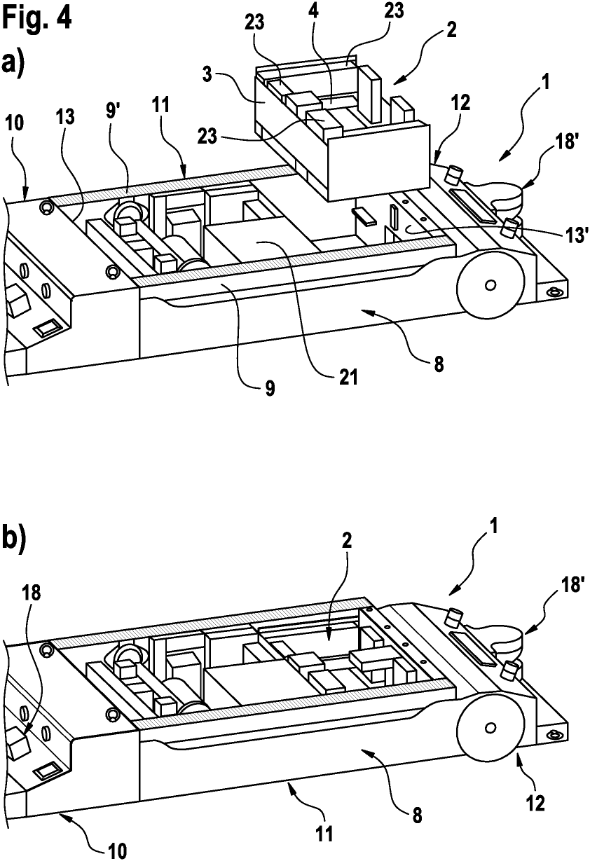

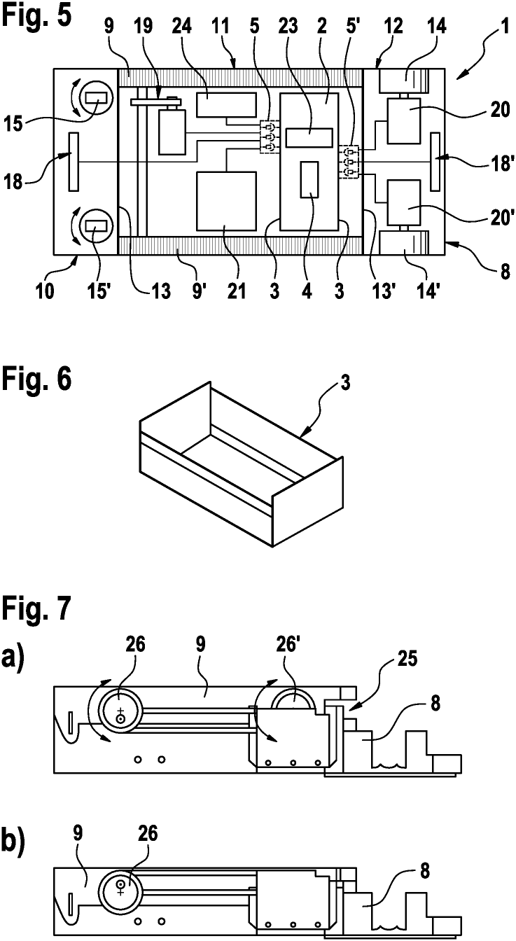

The driverless transport vehicle 1 serves for example for conveying payloads on smooth floors in production and assembly factories, for example for the purposes of transporting parts and components from and to the production line or in the parts warehouse. The transport vehicle 1 selects its traveling route autonomously on the basis of integrated space monitoring sensors (see 18, 18′ in FIGS. 4 and 5) and a control system (not illustrated here).

The transport vehicle 1 has a flat, compact chassis 8, in and on which all control and drive components are arranged.

In the embodiment shown, the transport vehicle 1 moves on a pair of support wheels 15 and a pair of drive wheels 14. The drive wheels 14 are driveable individually, independently of one another, and thus serve both for the propulsion and for the steering of the transport vehicle 1.

For carrying the load or for the placement of the load, the transport vehicle 1 has two load carrier elements 9, 9′, which form a constituent part of a lifting apparatus 25. The load carrier elements 9, 9′ are of elongate form in a longitudinal direction or parallel to the direction of travel F and laterally flank the chassis 8 in the upper region. In the embodiment shown, each load carrier element 9, 9′ is configured as a box-like hollow body. To lift the load, the load carrier elements 9, 9′ can be lifted in a vertical lifting direction H by a lift travel 16 from a retracted parked position (view b) into a deployed transport position.

Load carrier elements 9, 9′ may be cross-connected by way of one or more struts, strips or panels (not shown here) in order to increase the stiffness and/or in order to realize a larger flat loading surface.

As shown in FIG. 2, the transport vehicle 1 is designed for preferentially transporting payloads in a separate payload carrier 6. The payload carrier 6 may be constructed in a variety of forms - in the form of a rack as shown, in the form of a trolley or roller trolley, or the like.

The payload carrier 6 is constructed such that the transport vehicle 1 with load carrier elements 9, 9′ in the parked position can travel under the payload carrier 6. The payload carrier 6 has two traverses 7, 7′ which run transversely with respect to the direction of travel and on which the load carrier elements are supported during the lifting and transporting of the payload carrier 6. In the embodiment shown, the traverses 7, 7′ are connected by way of two externally situated longitudinal members 17, 17′.

To transport the load, the transport vehicle 1 travels under the payload carrier 6 and activates the lifting apparatus 25. Here, the load carrier elements 9, 9′ are lifted in the lifting direction H, abut against the traverses 7, 7′, and lift the payload carrier 6 from the floor. The payload carrier 6 can thereupon be transported to the destination, and set down on the floor again there in the reverse sequence.

FIG. 3 shows an exemplary usage scenario of the transport vehicle 1 and corresponds substantially to the situation illustrated in FIG. 2b. An embodiment of the transport vehicle 1 is situated under the payload carrier 6, which is configured as a roller trolley. The payload carrier 6 is laden with a payload 22, which is composed of a wire-mesh box filled with sacks.

FIG. 4 shows an embodiment of the transport vehicle 1. An interchangeable module 2, which can be easily exchanged, is arranged in the interior of the chassis 8. Most of the electronic components 23 that are required for the closed-loop and open-loop control of the transport vehicle 1 are arranged in said interchangeable module. For example, an electronic control unit 4 and further elements of the vehicle control system are accommodated centrally therein.

The interchangeable module 2 has a dedicated module housing 3, which is inserted into a seat provided for it in the chassis 8 and is fixed therein by means of a small number of fastening elements (not explicitly illustrated here) such as for example screws, bayonet fasteners, tension clamps or other fastening elements that can be released relatively easily and quickly.

In FIG. 5 the transport vehicle 1 is, in a longitudinal direction or along the direction of travel F, divided structurally and functionally into three vehicle portions that are separated from one another by a front partition 13 and a rear partition 13′.

A first sensor arrangement 18 for sensing the vehicle surroundings is situated in the front vehicle portion 10, and the two support wheels 15, 15′ are also arranged therein.

The interchangeable module 2 is arranged in the middle vehicle portion 11. A lifting drive 19 for actuating the lifting apparatus 25, one or more electrical batteries 21, and possibly charging and electrical power components 24 for controlling charging operations, are situated in the middle vehicle portion 10 in addition to the interchangeable module.

A second sensor arrangement 18′ for sensing the vehicle surroundings, and the two drive wheels 14, 14′ together with their associated electrical traction drives 20, are situated in the rear vehicle portion 12.

In the embodiment shown, the interchangeable module 2 extends in a transverse direction substantially over the entire inner width of the middle vehicle portion 11.

The abovementioned components from different vehicle portions must be connected to various electronic components 23 and to the electronic control unit 4 within the interchangeable module 2. For this purpose, in the embodiment shown, the interchangeable module 2 has in each case one combined electrical interface 5, 5′ at the front side and at the rear side. The front electrical interface 5 serves for the connection of electrical and electronic components from the front 10 and the middle 11 vehicle portions, whereas the rear electrical interface 5′ is provided for the connection of electrical and electronic components from the rear vehicle portion 12. It is however equally conceivable for a single common electrical interface to be provided, which is provided for the establishment of all necessary connections to components outside the interchangeable module 2.

It would furthermore be conceivable for such a common electrical interface to be designed such that the connection process and the disconnection process respectively forcibly take place automatically during the insertion and removal of the interchangeable module 2 into and from the transport vehicle 1 respectively. Such a common interface could for example be arranged on the underside of the module housing 4.

The two sensor arrangements 18, 18′ are illustrated here merely by way of example and symbolically as a placeholder representing a real combination of multiple individual sensors arranged at different locations.

FIG. 6 shows an embodiment of the module housing 3. In the exemplary embodiment shown, the module housing 3 is produced from sheet metal. It is of substantially trough-like construction and has a sheet-metal profile bent in a U shape, which forms the base and the side walls of the module housing 3 and which is stiffened and stabilized at the front side and at the rear side by transverse metal sheets. For the installation of electronic components, the module housing 3 may be provided with all corresponding fastening interfaces such as bores, punched apertures, sheet-metal nuts, rails and the like.

FIG. 7 shows a partial side view of some elements of the lifting apparatus 25 of the transport vehicle 1 in the lifted transport position (view a) and in the lowered parked position (view b).

On each side of the transport vehicle 1, the lifting apparatus 25 has in each case two eccentric elements 26, 26′ of equal size, which act on the same load carrier element 9. The two eccentric elements 26, 20′ are coupled to one another by way of a wraparound drive, such that, when the lifting drive 19 is activated, said eccentric elements forcibly rotate simultaneously in the same direction and, in so doing, lift or lower the load carrier element 9. In order to reduce friction between the eccentric elements 3, 3′ and the load carrier element 9, each eccentric element 26, 26′ is equipped, radially at the outside, with a rolling bearing element by means of which said eccentric element rolls quietly and with low friction on the load carrier element 9.

1. A driverless automatically guided transport vehicle for transporting a load comprises:
a chassis with electrical and electronic control and drive components arranged therein; and
a removable interchangeable module in the chassis in which multiple electrical and/or electronic components are combined.

2. The transport vehicle as claimed in claim 1, wherein the interchangeable module has a module housing in which at least one of the electrical and electronic components are accommodated.

3. The transport vehicle as claimed in claim 1, wherein the interchangeable module comprises at least one electronic control unit.

4. The transport vehicle as claimed in claim 1, wherein the transport vehicle has a front vehicle portiona middle vehicle portion and a rear vehicle portion , wherein the front vehicle portion is separated from the middle vehicle portion by a front partition, and the rear vehicle portion is separated from the middle vehicle portionby a rear partition, and wherein the interchangeable module is arranged in the middle vehicle portion.

5. The transport vehicle as claimed in claim 4, wherein at least one first sensor arrangement for sensing the vehicle surroundings, and at least two vehicle wheels are arranged in the front vehicle portion.

6. The transport vehicle as claimed in claim 4, wherein at least one second sensor arrangement for sensing the vehicle surroundings, and at least two drive wheels and at least one traction drive, are arranged in the rear vehicle portion.

7. The transport vehicle as claimed in claim 4, wherein at least one lifting drive for actuating a lifting apparatus for the purposes of lifting the load is arranged in the middle vehicle portion.

8. The transport vehicle as claimed in claim 7, wherein the lifting apparatus is actuated by way of an eccentric drive.

9. The transport vehicle as claimed in claim 1, wherein electrical and/or electronic components from the front, middle and rear vehicle portions are connected to the interchangeable module via electrical lines.

10. The transport vehicle as claimed in claim 1, wherein the interchangeable module has at least one combined electrical interface which is designed for the simultaneous connection of multiple electrical and/or electronic components outside the interchangeable module.
